(19) United States
(12) Patent Application Publication
(10) Pub. No.: US 2015/0346786 A1
(43) Pub. Date: Dec. 3, 2015

(54) METHOD AND APPARATUS FOR PERFORMING POWER MANAGEMENT FUNCTIONS

(71) Applicant: SYMBOL TECHNOLOGIES, INC., Schaumburg, IL (US)

(72) Inventor: David T. Lundquist, Stony Brook, NY (US)

(73) Assignee: SYMBOL TECHNOLOGIES, INC., Schaumburg, IL (US)

(21) Appl. No.: 14/289,830

(22) Filed: May 29, 2014

(51) Int. Cl. G06F 1/26

(52) U.S. Cl. CPC G06F 1/26

(57) ABSTRACT

A method and apparatus are provided by which a mobile device performs power management functions. According to some embodiments, a controller detects a pattern of push events on at least a button of the mobile device and determines whether the detected pattern matches the stored pattern or not. The controller upon detecting that the detected pattern matches the stored patterns, transmits a signal to a processor of the mobile device to perform a predetermined power management function on the mobile device when the detected pattern matches the stored pattern wherein the predetermined function is associated with the stored pattern.

### FIELD OF THE DISCLOSURE

The present disclosure relates generally to mobile devices, and more particularly to mobile devices performing power management functions.

### BACKGROUND

Mobile device technology has grown rapidly over the past several years, providing capability to perform an ever-increasing variety of functionality. Most mobile devices include a physical power button to perform power management functions such as turning the mobile device on or off. One potential drawback of the physical power button on the mobile device is the potential for inadvert depressing of the power button, for example when the mobile device is in a user's pocket or within a purse, briefcase, computer bag, and the like. Inadvertent depressing of the power button may power up the mobile device which may thereafter result in unwanted battery drain, and hence an unnecessarily reduced battery life.

One solution to the above mentioned problem of inadvertently powering on the mobile device is to provide for a required longer duration press in order to distinguish an inadvertent power button press from an actual button press by the user. However, even the long duration power button press may be triggered accidently in some circumstances.

Thus, there is a need to have a method to enhance the user inputs required to power on the mobile device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 is a block diagram of a mobile device for operation in accordance with the some embodiments.

FIG. 2 is a flowchart for performing power management functions on the mobile device in accordance with some embodiments.

FIG. 3 illustrates a table including examples of push event patterns for performing various power management functions on the mobile device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Briefly, in accordance with the various embodiments, there is described herein, a method and apparatus by which a mobile device performs power management functions. According to some embodiments, a controller detects a pattern of push events on at least a button of the mobile device and determines whether the detected pattern matches any stored patterns or not. The controller, upon detecting that the detected pattern matches one of the stored patterns, transmits a signal to a processor of the mobile device to perform a predetermined power management function on the mobile device wherein the predetermined power management function is associated with the determined stored pattern.

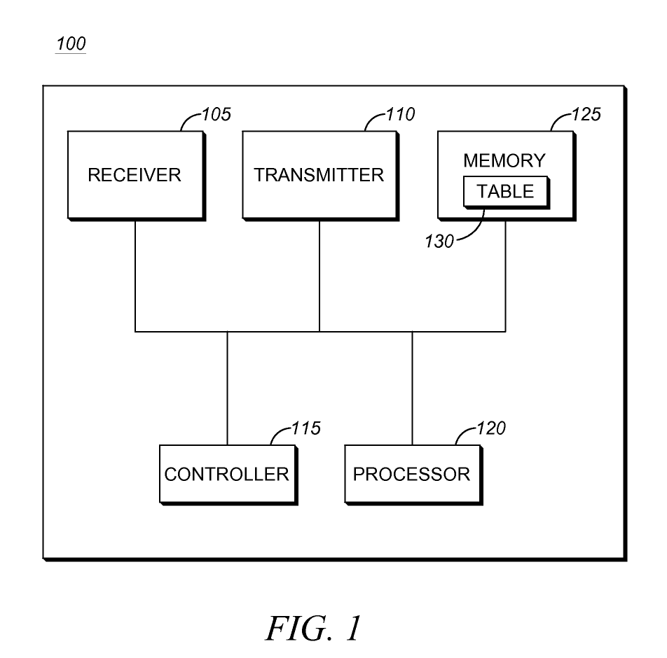

FIG. 1 is a block diagram of a mobile device 100 operating in accordance with various embodiments. The mobile device may take the form of, but is not limited to, wearable devices such as a smartphone, a tablet, a notebook computer, and the like. The mobile device 100 comprises a receiver 105, a transmitter 110, a controller 115, a processor 120, and a memory 125. In accordance with various embodiments, the receiver 105 of the mobile device 100 is tuned to a primary channel of the mobile device 100 to perform basic communication functionality. The transmitter 110 of the mobile device 100 can be tuned to communicate over various channels on which the mobile device 100 is programmed to talk to one or more peers, for example, other mobile devices, in the radio-to-radio mode. The transmitter 110 and the receiver 105 of the mobile device 100 together form a wireless transceiver to enable bi-directional wireless communication with other devices.

The controller 115 includes one or more microprocessors, microcontrollers, DSPs (digital signal processors), state machines, logic circuitry, or any other mechanism that is capable of processing information based on operational or programming instructions. The controller 115 of the mobile device 100 is a low-powered entity that is designed to use minimal battery power and thus can operate even when the mobile device 100 is turned off with limited impact on the battery capacity of the mobile device 100. The controller 115 of the mobile device 100 is configured to detect a pattern of push events on at least one button of the mobile device 100 and in response determine whether the detected pattern matches any of the stored patterns in the memory 125 of the mobile device 100. In accordance with various embodiments, the button can be any button for performing power management functions and/or alternatively any button having an alternate primary function including, for example, a power button, a volume up button, a volume down button, a camera button, and/or a lock button, or any combination thereof. The controller 115 of the mobile device 100, upon determining that the detected pattern matches at least one stored pattern, sends a signal to the processor 120 to perform a predetermined power management function associated with the determined stored pattern.

The memory 125 of the mobile device 100 includes a stored table 130 which includes entries representing a plurality of predetermined push event patterns on one or more buttons on the mobile device 100 and their associated power management functions. As discussed above, the button can be any button or a combination of buttons on the mobile device 100. Each of the plurality of predetermined push event patterns stored in the table 130 of the memory 125 is characterized by a predefined one or more buttons on the mobile device 100 on which the push event needs to be detected, a predefined number of push events on the one or more buttons of the mobile device 100, a predefined sequence of push events on the one or more buttons of the mobile device 100, a predefined maximum and minimum duration of each push event, and a predefined maximum and minimum time interval between each push event on the one or more buttons of the mobile device 100. In accordance with various embodiments, the above mentioned parameters of the push event patterns, including, one or more buttons, the number of push event, the sequence of push event, the maximum and minimum duration of each push event, and the maximum and minimum time interval between multiple push events may be customized, for example, by a device user, a device owner, a service provider, or a manufacturer of the mobile device 100.

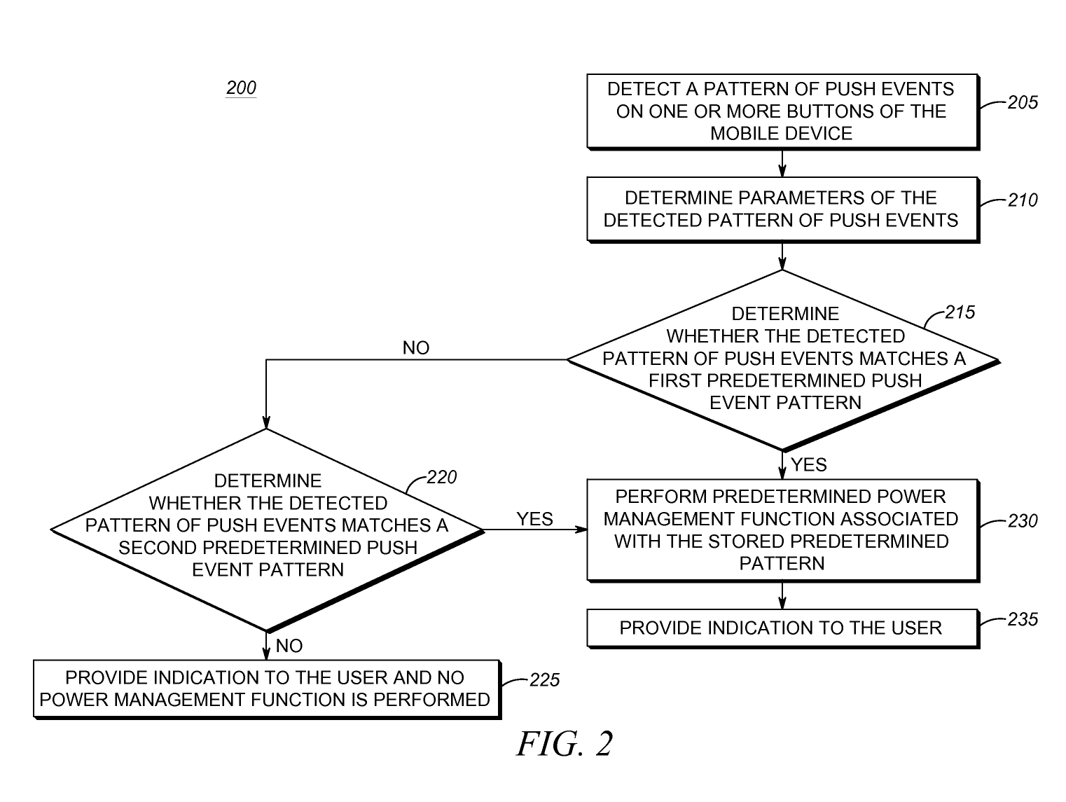

FIG. 2 is a flowchart 200 for performing power management functions on the mobile device 100 in accordance with some embodiments. At 205, the controller 115 detects a pattern of push events on one or more buttons of the mobile device 100. The controller 115, upon detecting the pattern of push events on the one or more buttons of the mobile device 100, determines various parameters of the detected pattern of push events such as the one or more buttons of the mobile device 100, a number of push events on the one or more buttons of the mobile device 100, a sequence of the push events, a duration of each push event, and a time interval between each push event on the one or more buttons of the mobile device 100 at 210. In accordance with various embodiments, the above determined parameters are then stored in the memory 125 of the mobile device 100 for further comparison with the plurality of predetermined push event patterns stored in the table 130 of the memory 125.

The controller 115 compares the above determined parameters with the parameters of each of the plurality of predetermined push event patterns to determine whether the detected pattern of push events matches any of the plurality of predetermined push event patterns. For instance, at 215, the controller 115 determines whether the detected pattern of push events matches a first predetermined push event pattern of the plurality of predetermined push event patterns by comparing (i) whether the one or more buttons on which the pattern of push events is detected matches the predefined one or more buttons of the first predetermined push event pattern, (ii) whether the determined number of push events matches the predefined number of push events of the first predetermined push event pattern, (iii) whether the determined sequence of the push events on the one or more buttons matches the predefined sequence of the first predetermined push event pattern, (iv) whether the determined duration of each push event is less than a predefined maximum duration and greater than a predefined minimum duration of push events of the first predetermined push event pattern, and (v) whether the determined time interval between each push event on the one or more buttons is less than the predefined maximum time interval and greater than minimum time interval of the first predetermined push event pattern. A person with ordinary skill in the art would understand that the above determination steps can be performed either simultaneously or in any order by the controller 115 of the mobile device 100. When the parameters of the detected pattern of push events do not match the parameters of the first predetermined push event pattern, the method proceeds to determining whether the detected pattern of push events matches a second predetermined push event pattern by comparing the parameters of the detected pattern of push events to a second predetermined push event pattern of the plurality of predetermined push event patterns at 220. The process is repeated until the parameters of the detected pattern of push events match the parameters of one of the plurality of predetermined push event patterns stored in the table 130 of the memory 125 of the mobile device 100. When the parameters of the detected pattern of push events do not match parameters of any of the plurality of predetermined push event patterns, the user may be notified of the result through an audio or visual indication at 225 and no power management function is performed.

In accordance with various embodiments, one or more logic circuits may be added to the controller 115 to detect and decipher the pattern of push events and confirm whether or not the detected pattern of push events matches a stored pattern. The logic circuits may take the form, for example, of discrete fixed function logic gates, programmable logic devices or a small microcontroller. In accordance with some embodiments, the use of a microcontroller is preferred in that the microcontroller can serve other power management functions and can be easily customized by the user.

When it is determined that the parameters of the detected pattern of push events matches the parameters of one of the plurality of predetermined push event patterns stored in the table 130 of the memory 125, the controller 115 sends a signal to the processor 120 of the mobile device 100 to perform a predetermined power management function associated with the determined push event pattern stored in the table 130 of the memory 125. The processor 120, upon receiving the signal from the controller 115, performs the predetermined power management function associated with the determined push event pattern stored in the table 130 of the memory 125 at 230. The predetermined power management function associated with each of the plurality of predetermined push event patterns is stored in the table 130 of the memory 125 of the mobile device 100. The predetermined power management functions include, but not limited to, activating the mobile device, muting the mobile device, resetting the mobile device, adjusting brightness of a display of the mobile device, or any other function related to the power management of the mobile device. In accordance with the various embodiments, the stored predetermined push event patterns and the power management functions associated with the stored predetermined push event patterns may be customized, for example, by a device user, a device owner, a service provider, or a manufacturer of the mobile device 100. At 235, the controller 115 provides an audio or visual indication to notify to the user that the detected pattern of push event matches one of the plurality of predetermined push event patterns.

In summary, when it is determined that the detected pattern of push events matches one of the plurality of predetermined push event patterns stored in the table 130 of the memory 125 of the mobile device 100, the controller 115 sends a signal to the processor 120 to perform a predetermined power management function associated with the determined push event pattern stored in the table 130.

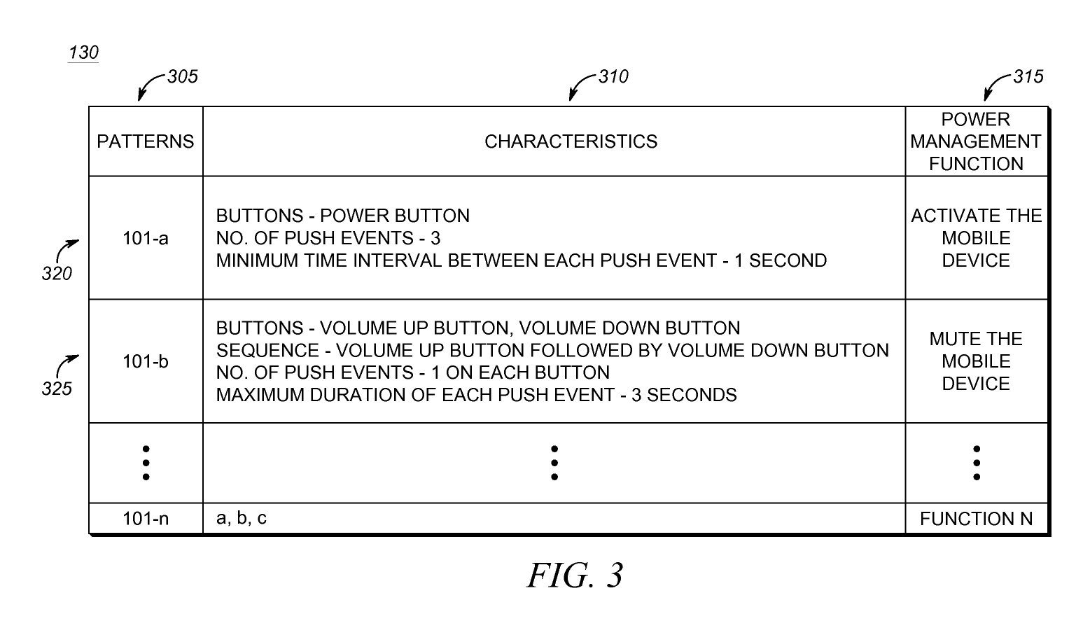

FIG. 3 illustrates a table 130 including examples of predetermined push event patterns for performing various power management functions in the mobile device 100 in accordance with the various embodiments of the present disclosure. A person with ordinary skill in the art would appreciate that these are merely non-limiting examples in accordance with various embodiments. The table 130 identifies the plurality of predetermined push event patterns in column 305, the characteristics of each of the plurality of predetermined push event patterns in column 310, and the power management function associated with each of the plurality of predetermined push event pattern in column 315. Each row of the table 130 represents a particular push event pattern and the predetermined power management function associated with the particular push event pattern. For example, row 320 of the table 130 represents a pattern 101-a, for activating the mobile device, characterized by three push events on a power button having minimum time interval of 1 second between each push event. Similarly, row 325 of the table 130 represents a pattern 101-b, for muting the mobile device, characterized by one push event on each of the volume up button and the volume down button having maximum duration of 3 seconds for each push event. Similarly, other patterns (101-n) may be defined for performing other power management functions (function N). In accordance with various embodiments, more complex patterns consisting of long and short pulses analogous to Morse code may also be considered.

The present invention enhances the user input required to perform the power management functions on the mobile device 100 in order to reduce the possibility of inadvertent power state changes in the mobile device 100. Instead of using the simple push events or the longer duration push events that can be accidently triggered, the invention proposes multiple push event patterns on the one or more buttons of the mobile device 100 by using a low cost controller 115. In accordance with various embodiments, the use of more complex and unique patterns may also prevent an unauthorized user to misuse or perform any power management function on the mobile device 100.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for performing power management functions on a mobile device, the method comprising:
detecting a pattern of push events on one or more buttons of the mobile device;
determining whether the detected pattern matches a stored pattern; and
performing a predetermined power management function on the mobile device when the detected pattern matches the stored pattern wherein the predetermined function is associated with the stored pattern.

2. The method of claim 1, wherein detecting a pattern of push events on the one or more buttons of the mobile device further comprises detecting a pattern of push events on the one or more buttons of the mobile device within a predefined time period.

3. The method of claim 2, wherein the one or more buttons includes at least one of a power button, a volume up button, a volume down button, a camera button, a lock button or any other button on the mobile device with alternate primary functionality.

4. The method of claim 2, wherein the one or more buttons is a dedicated button on the mobile device for performing power management functions.

5. The method of claim 1, wherein detecting the pattern of push events on the one or more buttons comprises determining a number of push events, duration of each push event and a time interval between each push event on the one or more buttons of the mobile device.

6. The method of claim 1, wherein the stored pattern represents a predefined number of push events on the one or more buttons of the mobile device, predefined maximum and minimum duration of each push event and a predefined maximum and minimum time interval between each push event on the one or more buttons of the mobile device.

7. The method of claim 6, wherein the predefined number of push events on the one or more buttons and a predefined maximum and minimum time interval between multiple push events on the one or more buttons is customized by a user of the mobile device.

8. The method of claim 6, wherein determining whether the detected pattern matches the stored pattern comprises:
determining whether the determined number of push events matches the predefined number of push events on the one or more buttons of the mobile device;
determining whether the determined duration of each push event is less than a predefined maximum duration and greater than a predefined minimum duration of push events on the one or more buttons of the mobile device; and
determining whether the determined time interval between each push event on at least the button is less than the predefined maximum time interval and greater than minimum time interval.

9. The method of claim 1, wherein the predetermined action includes activating the mobile device, muting the mobile device, resetting the mobile device, and adjusting brightness of a display of the mobile device.

10. The method of claim 1, wherein the predetermined action associated with the stored pattern is defined by at least one of a mobile device user, a mobile device owner, a service provider, or a manufacturer of the mobile device.

11. The method of claim 1, further comprising:
notifying the user upon determining whether the detected pattern matches the stored pattern.

12. A mobile device comprising:
a controller configured to:
detect a pattern of push events on one or more buttons of the mobile device,
determine whether the detected pattern matches a stored pattern, and
sending a signal to a main processor when the detected pattern matches the stored pattern; and
the main processor coupled to the controller, the main processor configured to:
perform a predetermined power management function on the mobile device upon receiving the signal from the controller wherein the predetermined action is associated with the stored pattern.

13. The mobile device of claim 12, wherein the controller is a separate logic element in the mobile device capable of detecting the pattern of push events on the one or more buttons of the mobile device when the mobile device is powered off.

14. The mobile device of claim 12, wherein the controller is further configured to detect a pattern of push events on the one or more buttons of the mobile device within a predefined time period.

15. The mobile device of claim 12, wherein the button includes at least one of a power button, a volume up button, a volume down button, a camera button, and a lock button on the mobile device.

16. The mobile device of claim 12, wherein detecting the pattern of push events on the one or more buttons comprises determining a number of push events, duration of each push event and a time interval between each push event on the one or more buttons of the mobile device.

17. The mobile device of claim 12, wherein the stored pattern represents a predefined number of push events on the one or more buttons of the mobile device, predefined duration of each push event and a predefined maximum and minimum time interval between each push event on the one or more buttons of the mobile device.

18. The mobile device of claim 12, wherein the predetermined action includes activating the mobile device, muting the mobile device, resetting the mobile device, and adjusting brightness of a display of the mobile device.

19. The mobile device of claim 12, wherein the predetermined action associated with the stored pattern is defined by at least one of a mobile device user, a mobile device owner, a service provider, or a manufacturer of the mobile device.

20. The mobile device of claim 12, wherein the controller is further configured to:
provide an indication to a user of the mobile device when the detected pattern is different from the stored pattern.
